(19) United States
(12) Patent Application Publication
(10) Pub. No.: US 2006/0069681 A1
(43) Pub. Date: Mar. 30, 2006

(54) Method and means for finding recorded data in a database

(75) Inventor: Eric Lauper, Bern (CH)

Correspondence Address: PEARNE & GORDON LLP, 1801 EAST 9TH STREET, SUITE 1200, CLEVELAND, OH, 44114-3108, US

(73) Assignee: Swisscom Mobile AG, Bern (CH)

(21) Appl. No.: 11/236,075

(22) Filed: Sep. 27, 2005

(30) Foreign Application Priority Data
Sep. 28, 2004 (EP) 2004EP-104735

(51) Int. Cl. G06F 17/30

(52) U.S. Cl. 707/6; 707/100; 707/3

(57) ABSTRACT

A method and means for finding recorded data in a database are described. For this, a user of a mobile telephone with integrated digital camera can for example on the basis of a first digital image initiate over a mobile radio network a search for further images of other users in the database. To digital images, metafiles are appended whose metadata contain among others spatial, temporal, etc. information about the record. In case of partial correlation between the metadata of a first digital image with metadata of the further images of the database, the images from the database over the mobile radio network are forwarded to and displayed on the reproducing device of the mobile telephone.

### REFERENCE DATA

This application claims priority of European patent application 2004EP-104735, filed on Sep. 28, 2004, the contents of which are hereby incorporated by reference.

### FIELD OF THE INVENTION

The invention concerns a method and means for finding recorded data in a database according to the preamble of patent claims 1, 20 and 24.

### RELATED ART

Nowadays, storage media have ever increasing capacities, so that a user of a database can store many recorded data such as images for example with a service provider of databases and later find or sort them again. For selecting certain images (for example by searching for camera records of a particular object), the metadata attached to the data are still used for identifying an image according to name, time, etc. The metafile is either set (usually automatically) when recording with the camera or can be subsequently entered by the user in a memory area (e.g. PC hard disk, database).

In this sense, it is possible to perform object-oriented searches for images. This aspect is described exhaustively in U.S. 20040073578 and further allows the records to be localized and several recorded images to be composed spatially on the basis of a position sensor such as GPS. It is thus possible to generate stereo images as well as geographical records. Here, the metafile of the images consists of spatial information that is determined on the basis of a GPS system (navigation system) in connection with a camera and its orientation.

Records from a user's mobile phone camera are known from JP2003323440, where the user location and the distance of the camera to the recorded object are determined. Afterwards, the recorded data are stored in a remote database.

As a further aspect of the metafile according to a private (instead of a spatial) criterion, the search or separation of recorded images over peer network elements is also known from U.S. Pat. No. 6,229,100.

So far, however, it is not easy to connect images recorded by different users in a database on the basis of different kinds of metafiles.

### BRIEF SUMMARY OF THE INVENTION

The task of the invention thus consists in proposing a method and means that ensure as good a search as possible for recorded data in a database on the basis of a mobile device of a user.

A solution to the task occurs as far as the method aspect is concerned by a method with the characteristics of patent claim 1 and as far as the device aspect is concerned by a system and a mobile communication device with the characteristics of patent claims 20 and 24.

Advantageous improvements of the invention are indicated in the dependent claims.

From a method for finding digital recorded data, preferably camera images, in a database,
wherein recorded data are stored by a plurality of users over a telecommunication network in said database,
wherein at least certain recorded data are recorded with mobile recording devices,
wherein metadata are allocated in the database to at least certain recorded data of users,
wherein the metadata contain automatically determined location information,
according to the invention, location information is used by means of a mobile recording device as search criterion by a first user for finding recorded data of different users in the database. In doing so, said location information will usually indicate the location of said mobile recording device of the first user.

A correlation of metadata of the first user and of further users occurs for example for several roughly similar records of a common object that are/were also partly made by means of recording devices (such as mobile recording devices) of different users.

As metadata, mainly location-based information (location of the camera, location of the recorded object, radius around the desired location, street number, etc.) are generated mostly automatically by the recording device, but any other information can also be added (e.g. manually by the user himself). In this connection, a name, a user group, a color feature, a date, a time etc. can also constitute further metadata.

Hereinafter, “metafile” will mean a file with consolidated data and metadata.

The user of a mobile recording device (e.g. of a mobile phone with a camera) can thus have access to further desired images in the database that have been stored at another time by other users of the database. For this, only one record is made and an appending metafile generated that serves for finding images in the database. If the mobile recording device is connected with a reproducing device (which is the case for a mobile phone with a camera and LCD display), the found images can be displayed directly with the metafile that has been partly correlated in the database.

A searching/storing of recorded data from a mobile recording device in the database occurs over a communication network (such as e.g. a mobile radio network). This means that a communication network operator can bill this service for example through additional fees with the telephone bill of a user. The operator of the database (inasmuch as it is not the communication network operator) can also take part in the business as far as storage quantity and administrative costs are concerned.

Furthermore, a user can search, on the basis of a new metafile (e.g. for a location that is not yet seen) from his mobile recording device, for one or several images coming from the database. This can often be desired for example to enquire by means of a mobile device how the road holding, the weather etc. along a planned driving route is/will be.

### BRIEF DESCRIPTION OF THE DRAWINGS

One embodiment of the invention will be described hereafter in more detail on the basis of the drawing, in which:

FIG. 1 shows a diagrammatic representation of a system for using the inventive method.

### DETAILED DESCRIPTION OF THE INVENTION

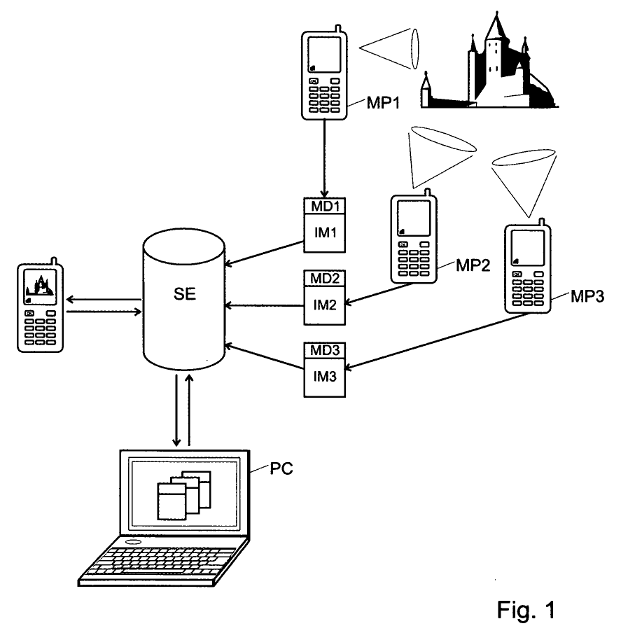

In FIG. 1, a possible case of execution of the method is represented, wherein three users record each one digital image IM1, IM2, IM3 of an object (here of a castle) by means of mobile devices with recording functions, such as mobile telephones MP1, MP2, MP3 with a camera. Additionally to each digital image IM1, IM2, IM3 a metafile MD1, MD2, MD3 is appended. The metafile MD1, MD2, MD3 has as simple metadata spatial coordinate data and temporal data that have been generated by a location-determining means such as a GPS system resp. by a clock of the mobile telephones MP1, MP2, MP3.

Simultaneously or shortly thereafter, the digital images IM1, IM2, IM3 are stored with their metafile MD1, MD2, MD3 in a common server SE. On the server SE a storage provider such as an Internet provider can for example administer a conventional database DB. The storage provider allocates the database designer a (for example private) memory space at no fee or (for a conventional customer) against payment.

For transmitting and storing (uploading) the images IM1, IM2, IM3 in the database, different methods can be used depending on which means are available to the user. For example, it is possible to transmit an image and its metafile to the database from a navigator of the mobile recording device MP1, MP2, MP3 via a link on an Internet page. One alternative would be to generate an e-mail from the mobile recording device MP1, MP2, MP3 with the target address of the server SE and to enclose as attachment to the e-mail the image IM1, IM2, IM3 and its metafile MD1, MD2, MD3. It is also possible to transmit an image with the metafile to the telephone number of the server SE and to store it in the server SE by means of a MMS from the mobile telephone MP1, MP2, MP3.

A further possibility for uploading can be via computer (such as e.g. a PC). For example, it is possible from a digital camera or from a mobile telephone to store recorded data with metafiles via Bluetooth, infrared, USB or a serial interface in a temporary database (hard disk of the PC or of an intermediary server) before they are uploaded in the database of the server SE. A physical transmission of the memory card between the digital camera and the computer is also possible.

After storing the digital images IM1, IM2, IM3 with their metadata MD1, MD2, MD3 in the server SE, a fourth user can perform a search for images of the castle by means of a PC computer or of a mobile device (such as a mobile telephone MP4) with reproducing means (such as an LCD display).

To search for images from a PC computer or a mobile device MP4 on the basis of a desired metafile MD4, different methods are conceivable. On the one hand, the fourth user can initiate a search directly via an Internet search page (e.g. by means of text items) or according to predefined search fields. A search on a WAP page is also possible with the mobile device. Furthermore, a search query can also be sent by SMS or e-mail by means of a mobile device or of a computer. Complicated metadata MD4 with location information, time domains, orientation characteristics between object and camera, distance etc. can also be defined directly from the mobile telephone MP4 (as well possibly as manually). They will thus be uploaded up to a COR unit for correlation with other metafiles on the server SE. The upload of the metafile occurs as mentioned in the previous paragraphs for uploading an image. If metadata MP4 also give indications about characteristics of the corresponding image IM4, the recorded data can also be uploaded in order to serve also as search criteria. An upload for metadata with recorded data can also be initiated by MMS, e-mail, FTP, WEB etc., in case for example recorded data very close to the recorded data IM4 are searched.

Additionally to the search, a need for identification can also arise, in particular in the sense of billing telephone costs, in case the fourth user of the embodiment according to FIG. 1 performs his search in the database DB from the PC computer or from his mobile device MP4 via a telecommunication network GSM, GPRS, MTS, HSCSD, Internet, etc. This can be for example solved by means of a password which the user has to confirm before the search query in order for an operator of the communication network and possibly of the database DB to be informed and to allow the operation to proceed. An identification can also occur through recognition of at least some parameters of the SIM card of the mobile telephone MP4. Further identification means such as biometric measuring systems can also be used for this purpose.

Such identification means can additionally be linked with access rights, on the one hand with respect to access to a telecommunication network, wherein the network operator knows if the mobile telephone MP 4 has been stolen or if the user has reached his maximum monthly telephone credit, and on the other hand with respect to access to e.g. private, protected or paying databases.

To search recorded data with metadata (e.g. by means of a correlation between the metadata MD4 of the record IM4 from the mobile telephone MP4 with further metadata MD1, MD2, MD3 of records IM1, IM2, IM3 of other users), the search query is first analyzed in the server SE and accepted or refused. A verification of possible rights of the user can additionally be performed. Optionally, the costs can be directly billed to the user by the mobile service provider (e.g. with the telephone bill).

The search results can then be sent (downloaded) to the user (searcher) from the server SE to the mobile telephone MP4. The sending format of searched and found images IM1, IM2, IM3 must however be adapted to the display means of the mobile telephone. For this, conversion means must be available along the server-mobile radio network-mobile telephone chain. The knowledge in the server SE of the correct sending format could also be derived for example from the used format for the search query or from a profile of the searcher identified in the server SE or on the basis of JINI or MEXE methods. This ensures that no conversion is required. Conversion means can however also be designed in the server SE or in the terminals in the case of separate recording device and reproducing device (e.g. mobile telephone MP4 with camera and PC computer with monitor). Preferred settings of the user can also be taken into account, so that the desired format of the download is selected. Furthermore, through an automatic checking of the setting possibilities of the mobile device as well as of the mobile telephone MP4 of the user, the format to be selected before downloading can be set.

As for uploading the metadata MD4 (possibly with the recorded data IM4), the downloading of recorded data IM1, IM2, IM3, . . . —with partly correlated metadata MD1, MD2, MD3—occurs through similar ways, i.e. for example over MMS, e-mail, WEB, WAP etc. over a communication network such as among others GSM, GPRS, UMTS, HSCSD or Internet. If the reproduction of the found images IM1, IM2, IM3 is possible by means of a computer monitor with Internet connection, the server SE can summarize the search results in an Internet page, e.g. first as small images that can be displayed in larger image format by mouse click.

For all upload and download operations, protection rights to the images of a user can be administered from the server SE. This means that the server SE can restitute at least part of the protection rights to the respective owner of one or several images of the database DB. This restitution can occur for example by means of financial resp. material advantages such as telephone credit or additional memory.

In order to protect some recorded data, it is possible to use on the mobile device, on the computer or on the server SE protection means such as e.g. DRM, waternames etc. In this manner, the author of the record, the operator of the server or the searcher can control the distribution of the (protected) records.

Search criteria (such as e.g. a geographic location) can be provided as metadata in a metafile of a record. For this, additionally to the location information, i.e. among others the location of the photographer (e.g. in a world coordinate form), a metafile and at least one further item of the following information (or metadata) can comprise:
a name e.g. of the location when recording,
a location of the recorded object, that can be determined for example on the basis of the location of the recording device, of the recording direction, if necessary with recording movement and distance to the object (focused when recording the image),
a time such as a year date, a month, a day and a time of day,
a recording characteristic of the recorded data such as setting parameters of the mobile recording device, focal length, optical aperture, exposure time etc or a recording position or movement,
a characteristic of the recorded data such as a color or shape aspect,
if necessary, further adjustable information of the mobile recording device such as a particularity of the recorded object or historical or cultural data, street numbers, etc. For this, the mobile devices or computers must have the necessary means, so that such information can be determined automatically resp. entered manually.
Characteristics from sensors in or close to the mobile device, for example temperature, speed, acceleration, medical or physiological sensors.

Additional metadata can be added, as long as they can be determined correctly in the server SE.

Temporal metadata are for example produced as time stamp by means of an electronically signed time in the metafile. The time can be determined with a clock in the mobile device, in the mobile radio network or from GPS signals.

Different photographic indications (focal length, sharpness, aperture of the objective, type of camera) as well as geometrical indications (position resp. movement related data, location, distance/direction of the camera to the object etc.) can be used as spatial information when recording an image. Several systems for determining such parameters are conceivable: distance sensors, navigation systems (GPS, Magellan, . . . ), coupled position sensors (two GPS), network-based location determining through network location of the mobile phone (e.g. between two network senders and/or receivers), etc.

Location information in the metadata can have different formats. It can be on the one hand determined world coordinates (e.g. GPS coordinates), in particular if a GPS measuring system is connected with the mobile device—e.g. in the case of current mobile telephones—or through an interface between a mobile phone and a GPS device (such as for sailing, flying, motoring or hiking, where many persons often use a GPS device additionally to their mobile phone). For this, a metrical search tolerance also can be used as search criteria, so that the probability of a positive search of images is increased, in particular if the database DB has only few available images within the radius of the user's mobile device indicated by the searcher. The radius can be defined by the searcher e.g. in meters or depending on a geographical location (such as a village, a city, etc.). The search tolerance can be set either manually by the user of the mobile device or automatically, so that in this case at least one image IM1 is found and shown on the mobile telephone MP4. Such variable settings of search criteria are particularly important in case for example a sailor finds himself close to the coast in fog and wishes to receive a view of the coast through his mobile phone with the GPS device. Searching for other rescue routes through an entry from another position, viewpoint etc. is useful when hiking in the mountains e.g. in case of bad weather or fog. In this example, the searched images could also even come from cameras operated in real time (livecams), so that the user immediately receives weather information from any location. A real-time search could also be set from the mobile device so that at regular time or route intervals, when the user moves, new images with updated metadata are searched and displayed. A further easy and useful application would also be to search the weather, in particular over a route, by setting targeted location metadata and to be able to determine oneself whether there is good sight for a safe drive or whether traffic obstructions such as congestions are to be expected.

Additionally to the metrical coordinates, the search for location-related metadata can be expanded with integrated names (e.g. of a place) of the user and/or of the recorded object. In the case of a PC computer, in particular for portable computers, location metadata can furthermore also be provided in a cookie.

Finally, many interesting applications of the present invention are generally that it is possible to help orient a user who has no direct informative sight possibilities.

A further possibility for reproducing could be to represent, by means of several images, that have for example been recorded by several users at different times, of known locations one three-dimensional or pseudo-three-dimensional image on the computer monitor or on the mobile device's display. If now images of several users (i.e. with several cameras at different locations) have been recorded for a same moving object in real time, the three-dimensional representation of the “assembled” object can be displayed dynamically.

For the 3D assembly of the images, a software must be available in the mobile device, in the computer or already in the server SE, that would use at least the spatial metadata and possibly the temporal metadata as static and dynamic input parameters of the combination. Such real-time software are nowadays state-of-the-art, e.g. for collating camera records of a skier or a football game scene from different viewpoints, where each camera includes a navigation system and means for determining several recording characteristics (distance with recognition points, direction camera-object-axis, etc.).

As search criteria, the spatial data of the castle or another image of the castle can be entered as metadata in the embodiment according to FIG. 1, after the three digital images IM1, IM2, IM3—according to the metadata MD1, MD2, MD3—have been displayed on a PC computer or a mobile device MP4 of the fourth user. Since the metafile MD1, MD2, MD3 here has a temporal parameter, the digital images IM1, IM2, IM3 can be represented chronologically as film viewing. It must be noted here that the access to the digital images IM1, IM2, IM3 occurs fully free of access rights, i.e. all users can select the images of other anonymous users without previous consultation with one another. In a similar way, metadata of the images IM1, IM2, IM3 could have different distances between the camera and the castle. In this case, the fourth user could perform a visual zoom representation of the castle.

It is also possible for a user to replace or complete a photograph at one location with a photograph of the same scene at another point in time, in order to replace a cloudy landscape image with a sunny image of another user.

The user of a mobile device can of course perform merely a download on the basis of a desired metafile (metadata upload) from the mobile device without transmission of a further image (data upload) up to the storage medium. In this case, the metafile can have location parameter of the current location of the user. He is thus more clearly aware whether he is at the right place, in case for example no house numbers or signposts are available. The search for important information by means of desired metadata is thus simple and fast. Further criteria can be added to the metadata resp. be removed therefrom, in case a search for an image is to be more accurate or wider. Additionally to the spatial and temporal parameters, a color or a name can for example be entered. On the basis of these further criteria, other metafiles are checked, so that the user receives useful information.

So far, talk has been of digital images IM1, IM2, IM3 that have been provided as recorded data by means of a camera of a mobile device. It would however also be possible to record videos or sound data that could have been uploaded on the server SE and stored in the database DB.

It is thus also conceivable that several users store their recorded data with the metadata in albums or partitions of a server (preferably of a server at the mobile radio operator's). When the recorded data are cleared/released (i.e. free access right by other users), the operator could offer the releasing user a reward to increase attractiveness.

In summary, a system with the following characteristics can include the device aspects of the invention in connection with a mobile radio network operator:
a database DB for storing and classifying several recorded data with metadata, having certain recorded data IM1, IM2, IM3 . . . with metadata MD1, MD2, MD3 of different users,
a mobile recording device MP4 of a first user, that is connected over a mobile radio network MN with the database DB,
a metadata generating module for generating a first metafile MD4 during a recording IM4 that has at least one location information of the record IM4,
a data administration system COR, where the location information of the record IM4 is indicated as criteria for searching for other records IM1, IM2, IM3 . . . of further users in the database DB.

If there is a partial correlation (not all metadata have to be correlated, but part thereof) between the metadata MD4 of the first user and the metadata MD1, MD2, MD3 . . . of other users, it is still possible to download the images IM1, IM2, IM3, . . . possibly with metadata MD1, MD2, MD3, . . . to the mobile device such as the mobile telephone MP4.

To receive the other recorded data IM1, IM2, IM3, . . . coming from the database DB, a reproducing device MP4, PC is connected with the data administration system COR over a telecommunication network, preferably the mobile radio network MN. The data administration system COR and the database DB can be integrated in a server SE.

A reproducing device MP4, PC for the recorded data IM1, IM2, IM3, . . . with partly correlated metadata MD1, MD2, MD3, . . . is connected over a communication network (preferably the mobile radio network MN) with the data administration system COR or more generally with the comprehensive server SE. In other words, the mobile telephone MP4 has an LCD display for displaying the recorded data IM1, IM2, IM3, . . . , with which a 2D or 3D representation can be made from the images IM1, IM2, IM3, . . .

In this case, it is a mobile recording device and a reproducing device that are integrated in a single mobile communication device such as a mobile telephone, a camera, an electronic organizer (PDA). It could also be separated mobile recording devices (camera with separate GPS) and mobile reproducing devices (PC-monitor) that are connected for example by means of a radio, infrared or Bluetooth interface for transmitting the recorded data. A further mobile radio network connection between the camera and the server SE should be provided. Further, the data of the camera could be forwarded to the PC computer and further forwarded by e-mail to the server SE for the search query.

A further problem for a user of a mobile device could arise if at the place of his record no mobile radio network reception of his mobile phone is available for an image search. One solution to this would be if the user has planned approximately his expected spatial travel destinations before arriving at this place (for mobile radio network reception), i.e. has performed a preliminary search with at least one somewhat broadband metafile that contains metadata of the location with a certain search tolerance of the travel destinations (e.g. in a radius of 2 km). The images found in the database could be stored in a storage module in connection with the mobile phone. An alternative would be that the mobile radio network operator establishes a storage medium or a storage quantity with pre-stored images that comprise the surroundings of a desired travel destination and sells to the user before his departure e.g. as CD, memory stick, “compact Flash” card or simply by sending at the user's e-mail address. Due to a large quantity of data, a storage module with a mobile communication device would be the most advantageous to connect, which would have a group of recorded data and metadata from the database.

The question now arises how to administer such a system with cost billing. The easiest would be for a communication service provider (such as a mobile radio network operator and/or fixed network operator) to administer all costs centrally. Even if the operator of the server SE and of the database DB do not belong to the communication service provider, a financial agreement could be concluded.

Here it is more the aspect “needs or service” of the user vis-à-vis the communication service provider that will be described.

On the one hand, the user uses the searching of recorded data over the communication network merely as customer. For this, the costs for transmitting the recorded data with metadata can be billed to him on a tariff-basis as telephone fee (according to the time or storage quantity, in particular for sending back many recorded data with partly correlated metadata). The search in the server SE could also be supported by the communication service provider financially as a flat fee or gradually according to operating expense or number of search results. The transmission costs of the search results to the searcher could further be borne through a billed MMS. PrePaid cards and PostPaid cards could also be debited.

On the other hand, the user contributes to designing the database DB when storing recorded data according to certain metadata. In this case, he can receive for sharing his property rights with the communication service provider and the database a reward that could for example be provided as money or telephone credit or free additional memory. If this user-designer still owns part of the property rights to his recorded data, he can conclude a deal with other operators.

A metafile can also have identification parameters as metadata, so that an access on stored images in a database is no longer anonymous or is possible only under certain own legal conditions. This aspect can lead to a financial advantage in case the owner wishes to offer image access to further users under payment of fees.

It would also be possible for any kind of anonymous users of a database to store their images there on the basis of their metafiles and (if allowed) to access further groups of images (according for example to spatial and temporal metadata of metafiles), that have been recorded by different users for an object and have been stored in the database already previously. When selecting and connecting these images by means of their metafiles, an assembly of these images (e.g. as chronological film) can be made. It could however also be possible for example to generate panorama scenes from several images (preferably from several users). If a photographer then notices too late a gap in his panorama images, he can at least access additional records (with similar metadata) of other people. Graphical software allows for example a panorama representation with overlapping images, in which colors and geometric aspects of the image data can be retouched. It would also be possible to generate additional three-dimensional representations with at least two images of the object.

From the viewpoint of today's state-of-the-art, many mobile devices such as mobile phones, PDAs, watches, etc. have integrated digital cameras. In connection with location-determining means, such metadata can be generated. Thus such metafiles can be generated simply by several users, who after recording can store their images on a common server with a service provider with search tools. Temporally and spatially classified images from several sources are thus available and can be linked by everyone. Instead of a central sever in a network, a peer-to-peer network of servers could also be provided for storing the records. An appropriate peer-to-peer payment should also be considered here.

Subsequently, a mobile communication device MP4 with at least one recording device and one reproducing device will thus be described, that are suited for recorded data IM4 with metadata MD4 resp. reproduced data IM1, IM2, IM3 with metadata MD1, MD2, MD3, wherein certain metadata include location information. According to the invention, metadata-based search data are directed from the recording device of a first user to a data administration system COR with a database DB. Metadata-based recorded data from other users of the database DB build search results to the search data that are sent back to the reproducing device of the first user.

The recording device can comprise automatic metadata generating means (such as a navigation and/or orientation system that is wither internal or drawn from the mobile radio network, a time stamp or any other date and time generating means, etc.) or be connected with such means.

The recording device also includes metadata generating means that can be set manually as well as electronic input means for a name, a position, etc. This can occur by input by means of the keyboard of a mobile telephone. More generally, it is an input module for characterizing metadata for a user-based selection of certain metadata. It could thus also be for example a software-assisted user interface that interrogates metadata from a menu.

On the side of the reproducing device, several reproducing means can be available for the imported recorded data, allowing for example a temporal sequencing (films) or different 2d to 3D combinations (land maps, houses, . . . ) of recorded data on the basis of their metadata. The representation means can include monitors, image projectors, microphones or other reproducing devices as well as corresponding software for controlling these reproducing devices.

An interpretation module that initiates a software-based user interface of the reproducing according to the metadata is used for identifying recorded data that are to be reproduced.

The data administration system CO can also consist of software-based user interfaces of the mobile communication device and the database DB can be integrated in or connected with a memory module in the mobile communication device. In other words, a mobile telephone can for example collect all inventive recording, searching, reproducing functions without compulsorily having to transit over a mobile radio network, in that a user, prior to a search, has downloaded many images from a database of an operator according to the desired metadata or has ordered from the operator a collection of images according to certain metadata. These images can be stored for subsequent search needs of the user in his mobile telephone or be browsed through by means of a memory module connected to the mobile telephone. This memory application is particularly interesting in case a user has planned a trip to a place where the network reception is poor or zero.

For searching according to desired metadata (location, time, place name, main color of an object . . . ), a query module for selecting the kind of metadata is connected to the recording device. It is also possible here to use for this the keyboard of a mobile telephone.

Finally, there is the possibility for at least one part of the database, preferably with the data desired by the searching person, to be integrated as memory module (RAM, Compact-Flash, . . . ) or connected (through memory stick via USB, hard disk, CD-ROM) to the mobile communication device.

1. Method for finding digital recorded data, preferably camera images, in a database,
wherein recorded data are stored by a plurality of users over a telecommunication network in said database,
wherein at least certain recorded data are recorded with mobile recording devices,
wherein in the database metadata are allocated to at least certain recorded data of users,
wherein the metadata contain automatically determined location information,
characterized in that
a record is made by a first user with a mobile device and a metafile relating to the record is generated, and the metafile is used as search criterion by a first user for searching the recorded data of different users in the database.

2. The method of claim 1, characterized in that said location information indicates the location of said mobile device.

3. The method of claim 1, characterized in that said location information indicates a location of a recorded object, that can be determined for example on the basis of the location of the mobile device, of a recording direction to the object, with recording movement and—for focused image recording—the distance to the object, or instead of the location of the recorded object at least another location defined by the user.

4. The method of claim 1, characterized in that said location information is indicated as geographical coordinates.

5. The method of claim 1, characterized that said location information is determined in the mobile radio network.

6. The method of claim 1, characterized that said location information includes geographical place names that are determined automatically on the basis of geographical coordinates.

7. The method of claim 1, characterized that further to said location information, additional location information, such as street names or numbers, the surrounding of places or a zone around a geographical point, can be entered manually by the user in the mobile device.

8. The method of claim 1, characterized in that further to said location information, the metadata of at last one record include at least one of the following further indications:
a name of a user group of the database or of the photographer
a time, such as a year date, a month, a day, a time of day,
a recording characteristic of the recorded data such as setting parameters of the mobile device such as focal length, optical aperture, exposure time or a recording position or movement,
a characteristic of the recorded data such as a color or shape aspect,
further adjustable information of the mobile recording device such as a particularity of the recorded object or historical or cultural data.

9. The method of claim 1, characterized in that the location information of the metadata are determined by means of a position determining means such as a GPS or network-based localization means.

10. The method of claim 1, characterized in that recorded data contain video images or sound sequences.

11. The method of claim 1, characterized in that on one of the reproducing devices connected with the database a—preferably software-assisted—reproduction of a group of records with partly correlated metadata occurs according to one of the metadata as spatial, alphabetical, chronological reproduction sequence or as two- or three-dimensional panorama of the records.

12. The method of claim 11, characterized in that by comparing approximately similar areas between recorded data, a combination of the recorded data can be made as a panorama.

13. The method of claim 1, characterized in that a mobile radio network service provider bills to a user the transmission costs of the recorded data and metadata between the database and a mobile device for recording and/or reproducing recorded data.

14. The method of claim 1, characterized in that the database operator bills storage and administration costs of the recorded data and metadata to the user for the storing or the desired downloading of recorded data after the search.

15. The method of claim 13, characterized in that on the basis of technical services of the mobile radio network service provider and the database operator there is a financial agreement between them through a telephone bill at a lower price and/or on the other hand through increased memory space.

16. The method of claim 13, characterized in that a reward, preferably as private additional memory space and/or telephone credit, is awarded to a user who as contractor contributes to designing the database with recorded data and metadata.

17. The method of claim 13, characterized in that a reward, preferably as private additional memory space with the database operator and/or telephone credit with the mobile radio network service provider, is awarded to a user who contributes to designing part of the database with private recorded data and metadata if as many further users as possible search and possibly download his private records and metadata in the database.

18. The method of claim 1, characterized in that access rights to a user's record stored in the database are awarded to further users for downloading this record.

19. The method of claim 1, characterized in that recorded data and metadata with different data types for images, videos or sounds such as *.jpeg, *.mpeg, *.raw, *.wav, *.gif can be transmitted between a mobile device and the database over different channels such as WEB, WAP etc. as integrated part of e-mails, MMS etc. and over communication networks GSM, UMTS, Internet, Bluetooth, and in that when downloading recorded data and metadata into the mobile device corresponding conversion means outside the database adapt the format required by the mobile device.

20. System with the following characteristics:
a database for storing and classifying several recorded data with metadata, having certain recorded data with metadata of different users,
a mobile device with a recording device of a first user, that is connected over a mobile radio network with the database,
a metadata generating module for generating a first metafile during a recording with the mobile device that has at least one location information of the record,
characterized by
a data administration system, where the metafile of the record can be used as criteria for searching for other records of further users in the database.

21. System according to claim 20, characterized in that for receiving other recorded data coming from the database, a reproducing device is connected the data administration system over a communication network, preferably the mobile radio network.

22. System according to claim 21, characterized in that the mobile device with a recording device and the reproducing device are integrated in a single mobile communication device such as a mobile telephone, a camera, a PDA.

23. System according to claim 20, characterized in that at least one billing unit is provided in the mobile radio network for the costs for storing the recorded data in the database and the costs for transmitting the recorded data and/or the metadata between the mobile device and the database and if necessary between the database and the reproducing device.

24. Mobile communication device with at least one recording device and one reproducing device, suitable for recorded data with metadata resp. for reproduced data with metadata,
wherein certain metadata comprise location information,
characterized in that
metadata-based search data from the recording device of a first user can be directed to a data administration system with a database, and metadata-based recorded data of other users of the database build search results to the search data, that can be directed to the reproducing device of the first user.

25. Mobile communication device according to claim 24, characterized in that the recording device with automatic metadata-generating means such as an internal or a mobile radio network-related navigation and/or orientation system is connected with or includes time or data generating means.

26. Mobile communication device according to claim 24, characterized in that the recording device resp. devices include manually adjustable metadata generating means and electronic input means for a name, a position, etc.

27. Mobile communication device according to claim 26, characterized by an input module for characterizing metadata for a user-based selection of certain metadata.

28. Mobile communication device according to claim 24, characterized in that the reproducing device has several representation means for the imported recorded data, allowing a temporal sequencing or different 2D to 3D combinations of recorded data on the basis of their metadata and in that the representation means include monitors, image projectors or other reproducing devices as well as corresponding software for controlling these reproducing devices.

29. Mobile communication device according to claim 28, characterized by an interpretation module for recognizing recorded data to be reproduced, wherein this module initiates a software-based user interface of the reproducing according to metadata.

30. Mobile communication device according to claim 24, characterized in that the data administration system is built as software-based user interface of the mobile communication device and the database is integrated in or connected to a memory module in the mobile communication device.
